(19) United States
(12) Patent Application Publication
(10) Pub. No.: US 2008/0276816 A1
(43) Pub. Date: Nov. 13, 2008

(54) Method for Automatically Adjusting Pressure Between Rotary Bodies in a Printing Press and Printing Press for Carrying out the Method

(75) Inventors: Felix Dorenkamp, Muhlhausen (DE); Peter Heiler, Forst (DE); Ulrich Luckhardt, Koln (DE); Martin Mayer, Ladenburg (DE); Dieter Schaffrath, Lorsch (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/119,040

(22) Filed: May 12, 2008

(30) Foreign Application Priority Data
May 11, 2007 (DE) 10 2007 022 079.2

(51) Int. Cl. B41F 13/34; B41F 33/08; B41F 13/24; B41F 31/32

(52) U.S. Cl. 101/484; 101/485

(57) ABSTRACT

A method for automatically adjusting a pressure between rotary bodies in a printing press, includes measuring an image of a pressure strip on printing material. An image of a first pressure strip formed by a first rotary body together with a second body and an image of a second pressure strip formed by the second rotary body together with a third rotary body, are measured on the printing material. A printing press for carrying out the method is also provided.

### CROSS-REFERENCE TO RELATED APPLICATION

This application claims the priority, under 35 U.S.C. § 119, of German Patent Application DE 10 2007 022 079.2, filed May 11, 2007; the prior application is herewith incorporated by reference in its entirety.

### BACKGROUND OF THE INVENTION

### Field of the Invention

The present invention relates to a method of automatically adjusting pressure between rotary bodies in a printing press, in which an image of a pressure strip is measured on printing material. The present invention also relates to a printing press for carrying out the method.

During make-ready of a printing press, the adjacent rollers and cylinders in the press need to be adjusted in such a way that the correct amount of pressure is present in the nips between the rollers and cylinders. In general, at least one of two respective rotary bodies, i.e. rollers or cylinders that form a nip, has an elastic surface, which is flattened due to the pressure. That flattening is also known as a contact or pressure strip. The width of the pressure strip can be measured in a direction perpendicular to the axis of rotation of the roller and is known as the pressure strip width, which is a measure for the pressure that has been set and can be measured in various ways.

German Published, Non-Prosecuted Patent Application DE 102 11 870 A1, corresponding to U.S. Pat. No. 6,708,616, discloses monitoring a pressure strip created between a distributor roller and an ink applicator roller through the use of a CCD sensor, which is directed towards the ink applicator roller for that purpose. The rollers that are pressed against each other are kept at a standstill for a certain period of time in order to obtain a clear image of the pressure strip on the ink applicator roller. Subsequently, the rollers are rotated into a position in which the image of the pressure strip on the ink applicator roller is easily accessible for the CCD sensor.

German Patent DE 44 27 967 B4, corresponding to U.S. Pat. No. 5,448,949, discloses measuring the width of a pressure strip created in the nip between an ink applicator roller and a plate cylinder on the basis of the image of the pressure strip that has been transferred to the printed sheet. The measurement of the pressure strip image is taken by optoelectronic scanning. The sensor used for optoelectronic scanning transmits the measured signals to a control unit, which may or may not be a closed-loop control unit. Based on those signals, the control unit generates adjustment signals for controlling an actuating motor, which adjusts the ink applicator roller in such a way as to set the correct pressure between the ink applicator roller and the plate cylinder.

Exclusively measuring the pressure strip formed in the nip between the ink applicator roller and the plate cylinder does not seem to be sufficient in view of the structural and functional complexity of modern roller-type inking units.

### BRIEF SUMMARY OF THE INVENTION

It is accordingly an object of the invention to provide a method for automatically adjusting pressure between rotary bodies in a printing press and a printing press for carrying out the method, which overcome the hereinafore-mentioned disadvantages of the heretofore-known methods and devices of this general type and which are more suitable for complex modern roller-type inking units.

With the foregoing and other objects in view there is provided, in accordance with the invention, a method for automatically adjusting a pressure between rotary bodies in a printing press. The method comprises measuring an image of a first pressure strip formed by a first rotary body together with a second rotary body and an image of a second pressure strip formed by the second rotary body together with a third rotary body, on printing material. This method is more suitable for complex modern roller-type inking units because it permits the interaction between the rollers to be taken into account.

In accordance with another mode of the invention, an electronic control unit controls a first actuating motor and a second actuating motor as a function of measurement signals of a measuring device for measuring the two images of the two pressure strips in order to adjust the pressure strips. In this context, the first actuating motor adjusts the second pressure strip primarily or in a main effect and adjusts the first pressure strip secondarily or in a side effect. Moreover, the second actuating motor adjusts the first pressure strip primarily or in the main effect and the second pressure strip secondarily or in the side effect.

In accordance with a further mode of the invention, the two actuating motors adjust the positions of the second rotary body and the third rotary body relative to the first rotary body in such a way that a common center connecting line of the first rotary body and of the second rotary body and a common center connecting line of the second rotary body and of the third rotary body form an angle that is not 90°, is larger than 0° and is smaller than 180°.

In accordance with an added mode of the invention, a final target value of the width of the first pressure strip and a final target value of the width of the second pressure strip are adjusted on the basis of the measurement of only the image of the first pressure strip and the image of the second pressure strip, but of no further image of the two pressure strips. In this context, the final target value of the width of the first pressure strip and the final target value of the width of the second pressure strip are adjusted in a single motor operation of the first actuating motor following the measurement of the images and a single motor operation of the second actuating motor following the measurement of the images.

In accordance with an additional mode of the invention, the first rotary body is a plate cylinder, the second rotary body is an ink applicator roller, and the third rotary body is a distributor roller.

In accordance with yet another mode of the invention, the two images are measured on one and the same printing sheet.

In accordance with yet a further mode of the invention, the two pressure strips are static pressure strips, which are generated between the rotary bodies while they are at a rotary standstill.

With the objects of the invention in view, there is concomitantly provided a printing press for carrying out the method of the invention or one of its developments.

Other features which are considered as characteristic for the invention are set forth in the appended claims.

Although the invention is illustrated and described herein as embodied in a method for automatically adjusting pressure between rotary bodies in a printing press and a printing press for carrying out the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a plate cylinder, an ink applicator roller and a distributor roller, between which pressure is adjusted;

FIG. 2 is a cross-sectional view showing geometric features of the configuration of the rotary bodies of FIG. 1;

FIG. 3 is a flow chart for an adjustment of measurement strips between the rotary bodies; and

FIG. 4 is a block diagram of a measurement and control device for automated implementation of the adjustment method.

### DETAILED DESCRIPTION OF THE INVENTION

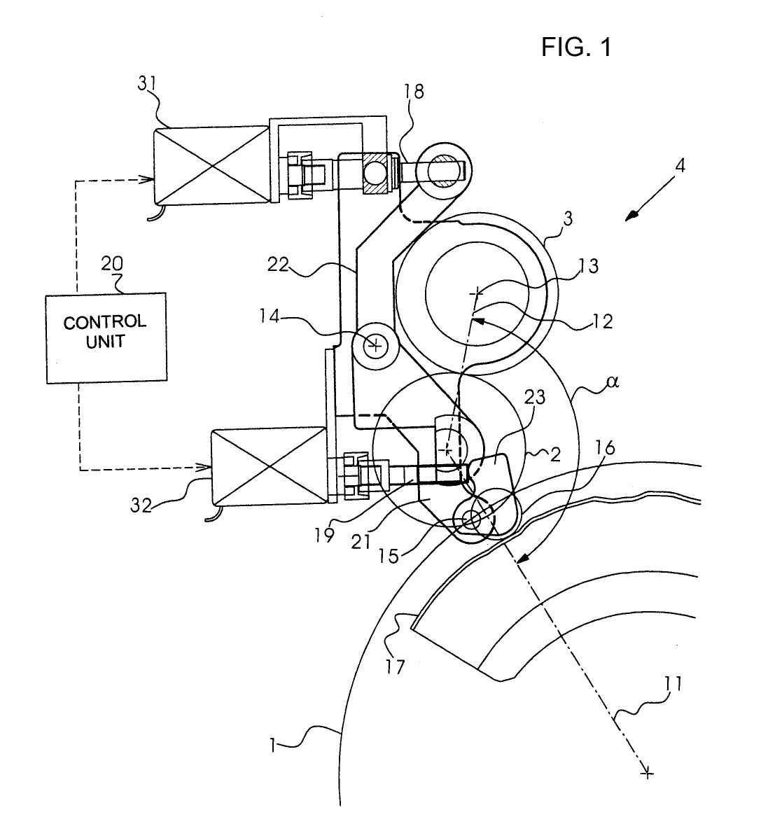

Referring now to the figures of the drawings in detail and first, particularly, to FIG. 1 thereof, there is seen a first rotary body 1, a second rotary body 2 and a third rotary body 3 as parts of a printing press 4. The first rotary body 1 is a plate cylinder for lithographic offset printing. The second rotary body 2 is an ink applicator roller having an elastic circumferential surface and engaging with the first rotary body 1 during printing. The third rotary body 3 is a distributor roller that oscillates in the axial direction and is equipped with a coaxial drive gear. The third rotary body 3 engages with the second rotary body 2. A common first center connecting line 11 of the first and second rotary bodies 1, 2 and a common second center connecting line 12 of the second and third rotary bodies 2, 3 form an angle α. The angle α between the center connecting lines 11, 12 is larger than 0° and smaller than 180°, but not a right angle. Rather, it is an obtuse angle.

A first lever 21 is supported so as to pivot about the axis of rotation or center 13 of the third rotary body 3. A second lever 22 is attached to the first lever 21 through a swivel joint 14. A third lever 23 is attached to the first lever 21 through a further swivel joint 15. A roller 16 following a control cam 17 is supported for rotation in the third lever 23. Pivoting of the control cam 17 about the center of the first rotary body 1 causes the first lever 21, together with the second and third levers 22, 23, to pivot about the center 13 of the third rotary body 3 in order to engage the second rotary body 2 with the first rotary body 1 and to disengage the second rotary body 2 from the first rotary body 1.

A first electric actuating motor 31 is disposed on the second lever 22 for pivoting the second lever 22 about the swivel joint 14. The first actuating motor 31 acts on a first arm of the second lever 22 through a screw drive mechanism 18. A second arm of the second lever 22 supports the second rotary body 2. A second electric actuating motor 32 is attached to the first lever 21. The second actuating motor 32 acts through a further screw drive mechanism 19 on the third lever 23 to pivot the third lever 23, together with the roller 16 supported therein, about the swivel joint 15. Pivoting the third lever 23 in this way causes the first lever 21 to pivot about the center 13 of the third rotary body 3.

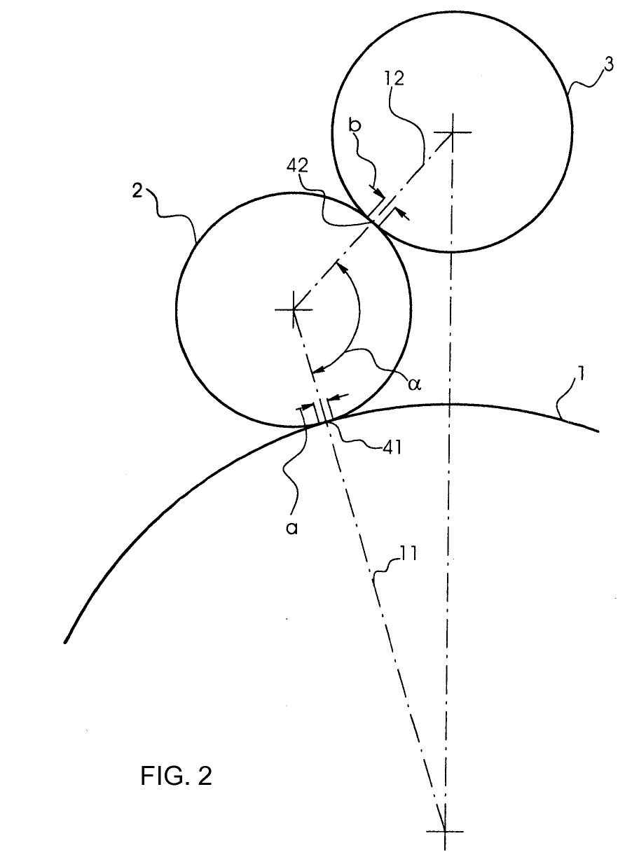

The second actuating motor 32 is operated to adjust the pressure in a common first nip 41 (see FIG. 2) between the first and second rotary bodies 1, 2 for the purpose of metering an amount of fluid or ink that is transferred from the second rotary body 2 to the first rotary body 1.

The first actuating motor 31 is operated to adjust the pressure in a common second nip 42 (see FIG. 2) between the second and third rotary bodies 2, 3 for the purpose of metering an amount of fluid or ink that is transferred from the third rotary body 3 to the second rotary body 2.

Due to the fact that the angle α is not a right angle, for structural reasons, operation of the first actuating motor 31 inevitably causes not only the desired adjustment of a pressure strip width b in the second nip 42 but, as an undesired side effect, also influences the size of a pressure strip width a in the first nip 41.

FIG. 2 is a diagrammatic representation of the trigonometric conditions of the configuration of the rotary bodies 1, 2, and 3. The figure clearly shows that, since the size of the angle α is not 90°, the adjustment of the roller engagement in the second nip 42 affects the roller engagement in the first nip 41.

FIG. 3 is a flow chart of a method for automatic roller adjustment. Step 51 signifies the start of the method. This first step 51 includes washing the inking unit that includes the second and third rotary bodies 2, 3 and the printing unit that includes the first rotary body 1 and a blanket cylinder that engages with the first rotary body 1 during printing. In addition, step 51 includes adjusting metering elements such as metering sliders with zone keys of an ink fountain of the inking unit in such a way that all ink zones are opened to the same extent and meter out the same amount of ink in all ink zones over the printing width. Once the ink zone adjustment has been completed, ink is introduced into the inking unit from the ink fountain. At this point, a dampening unit associated with the inking unit is inactive.

If the roller adjustment method is carried out immediately after completion of a print job, the steps of washing, uniformly adjusting the ink zone openings, and introducing ink may be dispensed with. In this case, only the dampening unit needs to be deactivated to prevent it from supplying dampening solution.

Irrespective of whether the adjustment method is carried out following the print job or at any other point in time, the ink applicator rollers, including the second rotary body 2, and a dampening solution applicator roller of the dampening unit, are engaged with the first rotary body 1 in order to transfer the printing ink from the inking unit to the first rotary body 1 and the offset printing plate disposed thereon. This transfer of ink is carried out without any transfer of dampening solution onto the offset printing plate. This means that the offset printing plate accepts the ink even in non-printing, hydrophilic areas, which would otherwise be free of ink due to the dampening solution. As a consequence, in the variant of the method wherein the roller adjustment is carried out immediately after completion of the print job, the offset printing plate that is disposed on the rotary body 1 and has been used for the print job can be used for roller adjustment. In accordance with another variant of the method, an offset printing plate that is especially provided for roller adjustment purposes is mounted on the first rotary body 1 instead of the offset printing plate that has been used for the print job. This special offset printing plate has a homogeneous printing image, thus dispensing with the need to deactivate the dampening unit.

No matter which offset printing plate is used for roller adjustment, the next measure is to even out the distribution of ink in the inking unit and on the first rotary body 1 during a short period of operation of the printing unit, for example of 30 seconds. In the process, no printing material is being transported and printed.

In a step 52, a static contact or pressure strip is generated in the first nip 41 (see FIG. 2), and in a parallel step 53, a static contact or pressure strip is generated in the second nip 42. For this purpose, rotation of the first rotary body 1 and of the applicator rollers in engagement therewith, including the second rotary body 2, and rotation of the third rotary body 3, are brought to a standstill in an angular position wherein the leading edge of the printing plate is located immediately behind the last one of the ink applicator rollers as viewed in the direction of rotation of the first rotary body 1. Due to the standstill and the static pressure in the nips 41, 42, the printing ink is pressed out of the nips. As a result, strips lacking in ink are created in the region of the nips 41, 42 on the rotary bodies 1, 2, 3. The widths of these strips are proportional to the pressure between the rollers in the respective nip 41, 42 and substantially correspond to the pressure strip widths a, b (see FIG. 2).

When the rotary bodies 1, 2, 3 subsequently continue to be rotated, these pressure strips are visible on the circumferential surfaces of the rotary bodies 1, 2, 3 as pale strips. However, the rotary bodies are only rotated through a predefined angle, i.e. far enough for the pressure strip created in the nip 42 on the rotary body 2 to have rolled only once over the first rotary body 1 during rotation of the second rotary body 2. As a result, an image of the pressure strip that has been created in the second nip 42 is created on the first rotary body 1.

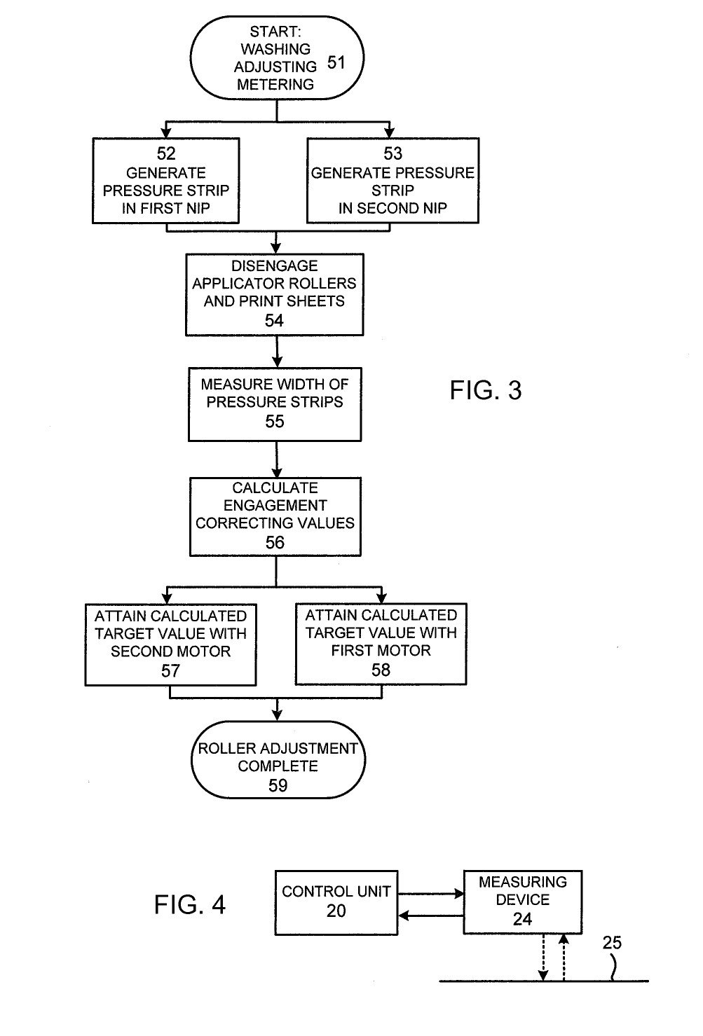

Subsequently, all applicator rollers, including the second rotary body 2, are disengaged from the first rotary body, and approximately 5 to 10 printing sheets are printed in the printing press 4 in a step 54. During printing, the pressure strip created on the first rotary body 1 in the nip 41 and the image of the pressure strip that has been created in the second nip 42 and transferred to the first rotary body 1 is transferred to the blanket cylinder, which is in engagement with the first rotary body 1. The blanket cylinder then transfers these two images to sheet-like printing material 25 (refer to FIG. 4).

In a subsequent step 55, the width of the pressure strips that have been transferred to the printing sheets is measured. For this purpose, the sheet on which the two pressure strips are best visible is selected from the 5 to 10 printed sheets.

In order to measure the widths of the images of the pressure strips on the printing material 25, i.e. on the printed sheet with the best images, the selected sheet is placed on a measurement table that includes an optoelectronic measuring device 24, for example a densitometric measuring device.

As is shown in FIG. 4, the measuring device 24 is connected to an electronic control unit 20, which is in turn connected to the actuating motors 31, 32 (see FIG. 1).

In a step 56, the control unit 20 calculates required correcting values of the engagement of the second rotary body with the first rotary body and of the engagement of the second rotary body with the third rotary body, based on measurement signals of the measuring device 24. As the control unit 20 calculates target values of the corrected engagement widths, it takes into account the fact that changing the engagement of the second rotary body with the third rotary body causes a change in the engagement of the second rotary body with the first rotary body. Upon calculation of the correction of the two engagements, i.e. of the distances between the centers of the first and second rotary bodies and between the second and third rotary bodies, the influence of one engagement on the other may be factored in by the control unit 20 on the basis of mathematical formulas stored in the control unit 20, for example a polynomial model describing the trigonometric relationship, or on the basis of a table of values stored in the control unit 20 and including pairs of values that have been calculated in an analytical way in accordance with the aforementioned formula or have been established by experiment, or on the basis of a corresponding function graph.

Based on this calculation, the control unit 20 controls the actuating motors 31, 32 in such a way that, in a step 57, the second actuating motor 32 acts to attain the calculated target value for the engagement of the second rotary body with the first rotary body and simultaneously or in parallel, in a step 58, the first actuating motor 31 acts to attain the calculated target value for the engagement of the second rotary body with the third rotary body. A successive implementation of steps 57, 58 would be conceivable, but would require more time.

Irrespective of whether the method steps 57, 58 are implemented simultaneously or successively, the decisive aspect is that the target value that is set in the respective step for the respective engagement or pressure in the respective nip 41, 42 is final, i.e. only one motor operation of the respective actuating motor 31, 32 is required to attain the respective target value. Therefore, no iterative repetition of steps 57, 58 is required.

If such an iterative repetition were required, initially only one of the two actuating motors 31, 32 would be actuated. Then, a new measurement of the width of the pressure strips represented on the printing material 25 would be taken to determine the target value for the other actuating motor based on the new measurement. Subsequently, the other actuating motor would be operated, and further iteration cycles would have to be carried out if necessary for the pressure or pressure strip widths a, b in the two nips 41, 42 to attain the correct value or to be within an acceptable tolerance of the target value.

In contrast, the determination of the two target values in step 56 ensures that once the correct setting has been achieved, the pressure or pressure strip width a, b in both nips 41, 42 is correct and no new measurement and no new adjustment need be carried out. In a step 59, the roller adjustment is thus completed.

1. A method for automatically adjusting a pressure between rotary bodies in a printing press, the method comprising the following steps:
measuring an image of a first pressure strip formed by a first rotary body together with a second rotary body and an image of a second pressure strip formed by the second rotary body together with a third rotary body, on printing material.

2. The method according to claim 1, which further comprises adjusting the pressure strips by actuating a first actuating motor and a second actuating motor with an electronic control unit depending on measurement signals of a measuring device for measuring widths of the images of the two pressure strips.

3. The method according to claim 2, which further comprises adjusting the second pressure strip in a main effect or primarily and adjusting the first pressure strip in a side effect or secondarily, with the first actuating motor.

4. The method according to claim 2, which further comprises adjusting the second rotary body and the third rotary body with the two actuating motors into a position relative to the first rotary body in which a common center connecting line of the first rotary body and of the second rotary body and a common center connecting line of the second rotary body and the third rotary body form an angle other than 90°, larger than 0° and smaller than 180°.

5. The method according to claim 2, which further comprises setting a final target value of the width of the first pressure strip and a final target value of the width of the second pressure strip on the basis of only the measurement of the image of the first pressure strip and the image of the second pressure strip and of no other image of the two pressure strips.

6. The method according to claim 5, which further comprises setting the final target value of the width of the first pressure strip and the final target value of the width of the second pressure strip by a single motor operation of the first actuating motor following the step of measuring the images, and by a single motor operation of the second actuating motor following the step of measuring the images.

7. The method according to claim 1, which further comprises providing a plate cylinder as the first rotary body, an ink applicator roller as the second rotary body and a distributor roller as the third rotary body.

8. The method according to claim 1, which further comprises carrying out the step of measuring the two images on one and the same printed sheet.

9. The method according to claim 1, which further comprises creating the two pressure strips as static pressure strips between the rotary bodies at a rotary standstill.

10. A printing press, comprising:
rotary bodies between which a pressure is automatically adjusted by the method according to claim 1.
